(19) United States
(12) Patent Application Publication
(10) Pub. No.: US 2008/0061551 A1
(43) Pub. Date: Mar. 13, 2008

(54) Coupling nuts, coupling assembly including a coupling nut, and method of forming a coupling nut

(76) Inventors: Tom M. Simmons, Hemlock, MI (US); John M. Simmons, Francis, UT (US); David M. Simmons, Saginaw, MI (US)

Correspondence Address: TRASK BRITT, P.O. BOX 2550, SALT LAKE CITY, UT, 84110, US

(21) Appl. No.: 11/519,985

(22) Filed: Sep. 12, 2006

(51) Int. Cl. F16L 47/00

(52) U.S. Cl. 285/249

(57) ABSTRACT

Coupling structures for tubing are disclosed. Particularly, caps configured for receiving one or more tube segments therein, and securing the tube segments to a component having protrusions thereon including bores therethrough in a fluid-tight manner are disclosed. The caps may have bores longitudinally therethrough for receiving the tube segments, the bore walls being free from projections to fit tightly against the tube segments. A longitudinally distal annular recess of the cap may be threaded to be secured to a component. In another embodiment, caps having separate apertures for receiving attachment elements to secure the cap and the component are disclosed. Caps configured with a bore for receiving a tube segment, and separate apertures for receiving attachment pins are additionally disclosed.

### BACKGROUND OF THE INVENTION

1. Field of the Invention

The present invention relates generally to fittings for tubing connections and, more particularly, to coupling assemblies including coupling nuts.

2. State of the Art

Numerous industries utilize metallic tubes, fittings, and various other “plumbing” components for handling and controlling critical fluid flow for many applications. Such components may be made of copper, stainless steel, and steel. Where the fluids being handled are under significant pressure or where containment integrity is critical, seals such as O-rings and flexible flat gaskets are typically utilized.

In particular applications such as semiconductor processing, the fluids involved react with and/or may be contaminated by the use of metallic components and conventional gaskets and elastomeric O-rings. Thus, in such industries, plumbing components are made of highly inert materials such as fluoropolymers, i.e., perfluoroalkoxy (PFA) and polytetrafluoroethylene (PTFE), for wetted components. In such applications, elastomeric O-rings are typically formed of two materials with a first traditional elastomeric material, such as silicon, encapsulated in a fluoropolymer coating. These O-rings are expensive and are subject to degradation and are typically considered to be suited for only a single use, requiring replacement when a connection is disassembled and reassembled.

Various fluoropolymer-based fittings and couplings have evolved for making connections between fluoropolymer components that do not utilize O-rings. Referring to FIG. 1, one conventional fitting includes a main fitting body 10 having a nose section 16 at a first end and an externally threaded portion 14 at a second, opposing end. The nose section 16 may be telescopically received into a flared end 36 of a section of tubing 34. A cylindrical cap nut 20 may be threadedly attachable to the main fitting body 10 in a manner to compress the flared end 36 of the tubing 34 down against the nose 16 of the main fitting body 10.

One conventional device for retaining the tubing 34 on the nose 16 is a resiliently deformable split ring 30 disposed about the tubing 34. The resiliently deformable split ring 30 may reside within an internal bore 28 in the cap nut 20 for retaining the flared end 36 of the tubing 34 in position around the main body nose 16. One conventional split ring (not shown) engages with an annular groove on the outside surface of the flared end of the tubing. However, if the split ring is pushed toward the fitting, the flared end of the tubing may shear off at the annular groove. Another conventional resiliently deformable split ring 30 (FIG. 1) may include a plurality of inwardly facing bosses 38 that cooperate with respective spaced apertures 40 formed in the tubing flared end 36. These split ring bosses 38 engage the tubing flared end to retain the tubing flared end 36 within the cap nut 20 and in functional position around the main body nose 16.

In such a fitting, it may be desirable, as shown in FIG. 2, for cap nut 50 to include an internal annular recess 72 for receiving a split ring 60. The split ring 60 may be fitted within the cap nut internal annular recess 72 prior to positioning around the tubing flared end 36. The internal annular recess 72 may include angled first and second side walls 74, 76 configured to engage respective first and second angled side surfaces 78 and 80 of the split ring 60. As the cap nut 50 is threaded on the main fitting body 10, the combination of the resiliency of the split ring 50 and the force of the cap nut internal annular recess second angular annular sidewall 76 acting against the split ring second angular annular side surface 80, causes the split ring bosses 46 to slip down into respective plastic tubing flared end spaced apertures 40.

Fitting components such as the cap nut 50 are conventionally formed by molding. However, a cap nut 50 having an internal annular recess 72 is difficult to mold. An interior mold for the internal annular recess 72 must be collapsed and removed before the cap nut 50 may be removed from the mold body. Another conventional method of forming the internal annular recess 72 is to use a computer numerically controlled (CNC) machine, for example a lathe or a mill, to form the recess, after molding the cap nut 50. The secondary operation using the CNC lathe is time consuming, and is an added expense to the cap nut formation.

Another conventional fitting does not include a split ring, thus the cap nut does not include an internal annular recess. However, without the use of the split ring, the material of the nose 16 may cold flow, causing the nose 16 to collapse and restrict the fluid flow through the fitting. Fluids may be transported through the fitting at high temperatures. For example some acids may be transported at temperatures of about 180° C., which may cause weakening of the material of the nose 16. In addition to restricting fluid flow, a weakened or collapsed nose 16 may enable the tubing 34 to slip off of the nose 16.

As may be appreciated, it would be advantageous to provide a fitting component which is easy to manufacture, and retains a split ring about a flared tubing.

### BRIEF SUMMARY OF THE INVENTION

One embodiment of the present invention comprises a coupling assembly comprising a fitting body, a tube configured for telescopically receiving the fitting body, a ring disposed about the tube, and a coupling nut comprising at least two components disposed about the tube and the split ring. The ring may be a resiliently deformable split ring configured for retaining the fitting body within the tube. The at least two components of the coupling nut may include a first annular component having exterior threads and a second annular component having at least two sets of interior threads. One set of interior threads may be left-hand threads, and the other set may be right-hand threads.

One set of threads of the second annular component may be threads configured to matingly engage the exterior threads of the first annular component and the other set of threads may be configured to matingly engage exterior threads of the fitting body.

The tube may include a plurality of spaced apertures therethrough and the ring may include a plurality of inwardly facing bosses that fit into and cooperate with the plurality of spaced apertures. In another embodiment, the ring includes an inwardly projecting lip extending into an annular groove within the tube.

The coupling nut may comprise an annular body, and the at least two components comprise a first longitudinal end of the annular body and a second longitudinal end of the annular body. The annular body of the coupling nut includes an internal annular recess. In one embodiment of the invention, the ring may include a body portion having a rectangular cross-section and the internal annular recess may comprises a counterbore of constant diameter for receiving the ring body portion. The internal annular recess may include internal flutes.

In another embodiment, the internal annular recess includes at least one tapered surface, and a second tapered surface, substantially parallel to the at least one tapered surface. The ring may include a tapered edge abutting the at least one tapered surface of the internal annular recess.

The at least two components of the coupling nut may comprise a first component having a bore therethrough, the bore including at least three sections, each of the three sections having a diameter greater than a diameter of a preceding section, and a second component having a bore therethrough, the bore including at least two sections, one section having a diameter greater than a diameter of the other section. The coupling nut may comprise a polymeric material.

Another embodiment of the invention is a coupling nut, comprising a first component having a bore therethrough, the bore including: a first section having a first diameter; a second section adjacent to the first section and having a second diameter lesser than the first diameter; and a third section adjacent to the second section and having a third diameter lesser than the second diameter. A second component of the coupling nut may have a first end receivable by the first section of the first component bore and having a bore therethrough, the bore including at least two sections, one section having a diameter greater than a diameter of the other section. The first component may be threadedly coupled with the second component. A portion of the first component defining the first section of the bore includes internal threads, and the first end of the second component includes external threads configured for engagement with the internal threads of the first component. A portion of the first component defining the third section of the bore may include right-hand internal threads, and the internal threads of the portion of the first component defining the first section of the bore may be left-hand threads. Alternatively, a portion of the first component defining the third section of the bore may include left-hand internal threads and the internal threads of the portion of the first component defining the first section of the bore may be right-hand threads.

In one embodiment, a portion of the first component defining the second section of the bore includes circumferentially disposed internal flutes. The first component further comprises a flange configured for engagement with an annular groove of the second component. The bore of the second component may include an outwardly flaring end section. The first component may include an annular channel with a tapered sidewall in open communication with the second section of the bore. The first component and the second component may each comprise a polymeric material.

Yet another embodiment of the invention comprises a method of forming a coupling nut, comprising molding a first component having a bore therethrough, the bore having at least three successive sections, each successive section having a diameter greater than the adjacent section, molding a second component having a bore therethrough, the bore having at least two successive sections, each successive section having a diameter greater than the adjacent section, and coupling the first component with the second component to form a coupling nut having an internal annular recess and a bore extending therethrough.

Coupling the first component with the second component may comprise threadedly coupling the first component with the second component. Molding the first component may comprise molding right-hand threads in a first end segment of the first component, defining a first end section of the bore and molding left-hand threads in a second end segment of the first component, defining a second end section of the bore. Molding the first component may comprise molding a central segment of the first component, defining a central section of the bore, with a plurality of flutes.

### BRIEF DESCRIPTION OF THE SEVERAL VIEWS OF THE DRAWINGS

The foregoing and other advantages of the present invention will become apparent upon review of the following detailed description and drawings in which:

FIG. 1 shows an exploded view of a conventional flare tubing fitting;

FIG. 2 shows a longitudinal sectional of another conventional flare tubing fitting;

FIG. 3 shows a flare tubing fitting of an embodiment of the present invention;

FIG. 4 illustrates a first component of a coupling nut as employed with the embodiment of FIG. 3;

FIG. 5 depicts a second component of a coupling nut as employed with the embodiment of FIG. 3;

FIG. 6 depicts a cross-sectional view of the flare tube fitting of the embodiment of FIG. 3;

FIG. 7 illustrates another embodiment of a flare tube fitting of the present invention;

FIG. 8 depicts a first component of a coupling nut as employed with the embodiment of FIG. 7;

FIG. 9 depicts a second component of a coupling nut as employed with the embodiment of FIG. 7;

FIG. 10 illustrates another embodiment of a flare tube fitting of the present invention;

FIG. 11 illustrates a second component of a coupling nut as employed with the embodiment of FIG. 7;

FIG. 12 shows a mold for a first component of the coupling nut of the present invention;

FIG. 13 shows a mold for a second component of the coupling nut of the present invention; and

FIG. 14 shows a flowchart for a method of using a coupling nut of the present invention.

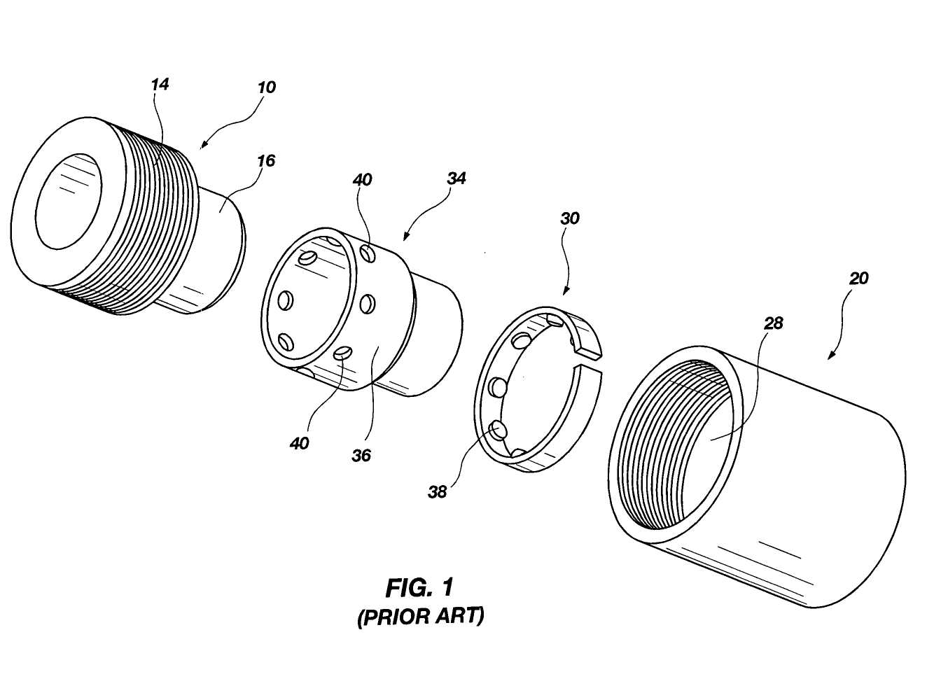

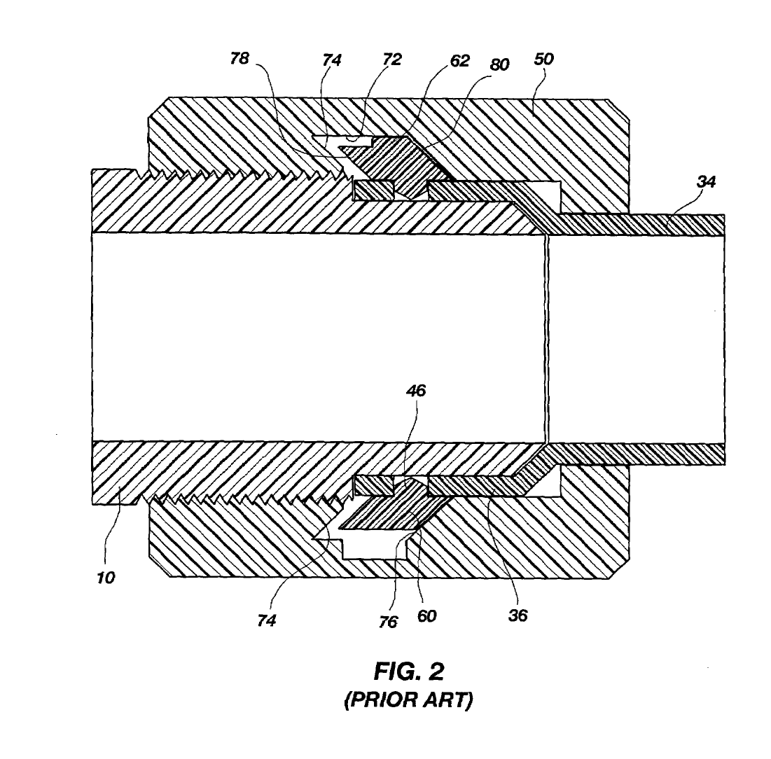

### DETAILED DESCRIPTION OF THE ILLUSTRATED EMBODIMENTS

The coupling and coupling nut according to the present invention may be used in a variety of applications, such as for coupling pipe or tubing ends together, or coupling a tubing end to components such as valves or manifolds.

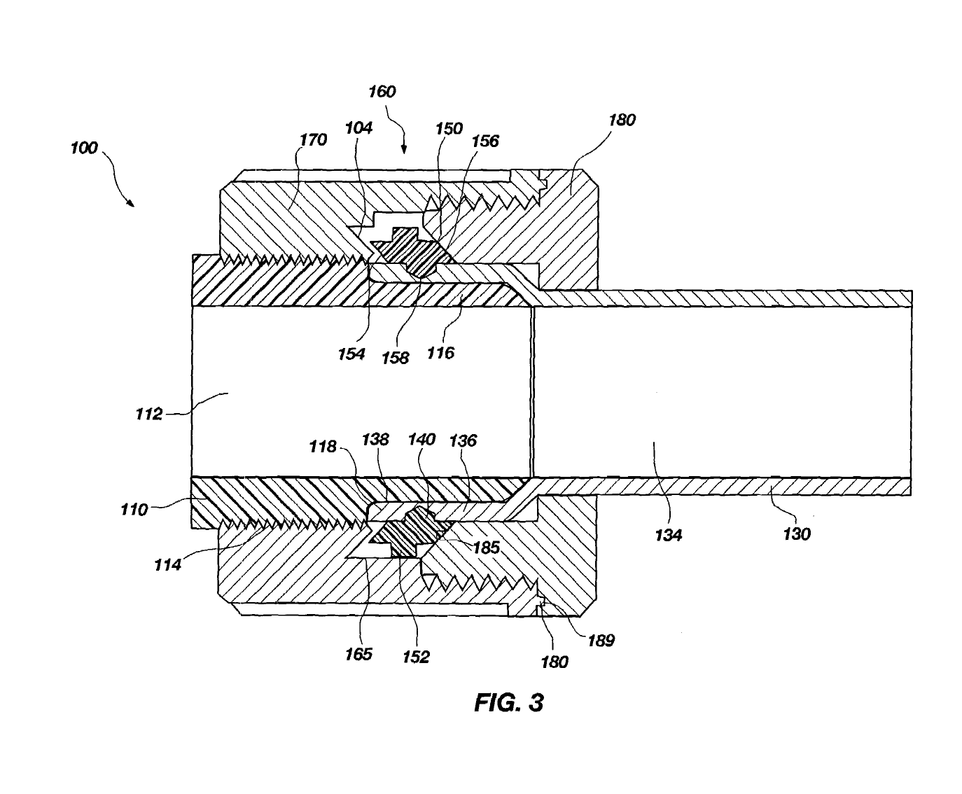

A first embodiment of coupling 100 according to the present invention is depicted in FIG. 3. The coupling 100 includes a fitting body 110 telescopically received within a tube 130, a resiliently deformable split ring 150 disposed about the tube 130, securely retaining the fitting body 110 therewithin, and a coupling nut 160 disposed about a junction of the fitting body 110 and tube 130, holding the split ring 150 about the junction. The coupling nut 160 may comprise at least two components, 170, 180, as described hereinbelow.

The fitting body 110 may have a nose section 116 at a first end, an externally threaded portion 114 at a second, opposing end, and a central fluid passageway 112 therethrough. The external diameter of the externally threaded portion 114 may be greater than the external diameter of the nose portion 116. An end of the externally threaded portion 114 may form a stop 118 between the nose portion 116 and the externally threaded portion 114. The central fluid passageway 112 through the fitting body 110 may have a substantially continuous diameter, although a central fluid passageway 112 having a variable diameter or a non-circular cross-section are also within the scope of the present invention. The term “diameter” as used herein, refers to the latitudinal extent of an element, which is not necessarily circular in shape.

The nose section 116 of the fitting body 110 may be telescopically receivable within a flared end 136 of the tube 130. With the nose section 116 received therein, a distal end 138 of the flared end 136 may be positioned adjacent the stop 118 of the fitting body 110. The flared end 136 need not abut the stop 118, but may be spaced apart therefrom. The flared end 136 may include a plurality of apertures 140 spaced circumferentially. A resiliently deformable split ring 150 may be disposed about the flared end 136 and include a plurality of inwardly facing bosses or protrusions 158 receivable within the apertures 140 of the tube 130. The resiliently deformable split ring 150 may be a split ring as described in U.S. Pat. No. 6,402,206 to Simmons et al., the entire disclosure of which is incorporated by reference.

A coupling nut 160 may be fitted about the flared tube 130 and the fitting body 110. The coupling nut 160 may include at least two components, a first component 170 and a second component 180. The first component 170 may comprise a first longitudinal end of the coupling nut, and the second component 180 may comprise a second, longitudinally opposing end of the coupling nut 160. The first component 170 and the second component 180 may be discrete components which may be coupled to form a coupling nut 160 having an annular recess 165 therein. The annular recess 165 may be configured for receiving the split ring 150. The first component 170 and the second component 180 may be threadedly coupled, as shown in FIG. 3, however, other methods of coupling the first component 170 and the second component 180 are within the scope of the present invention, as described hereinbelow.

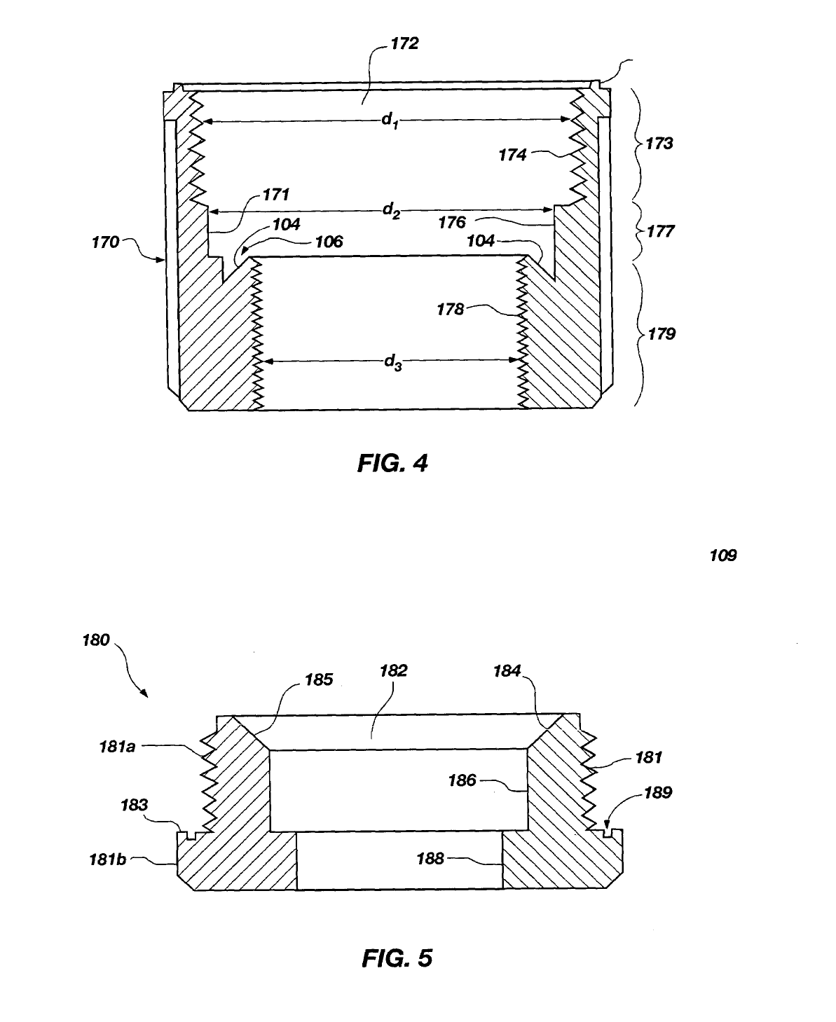

The coupling nut first component 170, shown in FIG. 4, may have a bore 172 therethrough, the bore 172 having at least three sections, each with a different cross-sectional area. The first bore section 174 may have the greatest diameter d₁ of the three sections. A first segment 173 of the coupling nut first component 170 may define the first bore section 174, and may be internally threaded. The second bore section 176, defined by a second segment 177 of the coupling nut first longitudinal component 170, may be configured to receive the split ring 150 therein, and may have a diameter d₂ smaller than the diameter d₁ of the first bore section 174. An inside facing surface of the second segment 177 may be substantially smooth, or unfeatured, to receive the split ring 150 therein. The third bore section 178, defined by a third segment 179 of the coupling nut first component 170, may be internally threaded, and may have a diameter d₃ smaller than the diameter d₂ of the second bore section. The externally threaded portion 114 of the fitting body 110 and the internal threads of the third segment 179 of the coupling nut 160 may be configured for mating engagement.

The internal threads of the first segment 173 of the coupling nut first component 170 may be right-hand threads, and the internal threads of the third segment 179 may be left-hand threads, or vice versus. Thus, as the coupling nut 360 is threaded onto the fitting body 110, the coupling nut first component 170 and second component 180 will be tightened together, rather than becoming unscrewed. In addition, the threads connecting the coupling nut components 170, 180 may be different size threads than the threads configured for attaching the fitting body 110 and the coupling nut first component 170. For example, the threads connecting the coupling nut components 170, 180 may have a greater pitch and thread depth than the threads configured for attaching the fitting body 110 and the coupling nut first component 170.

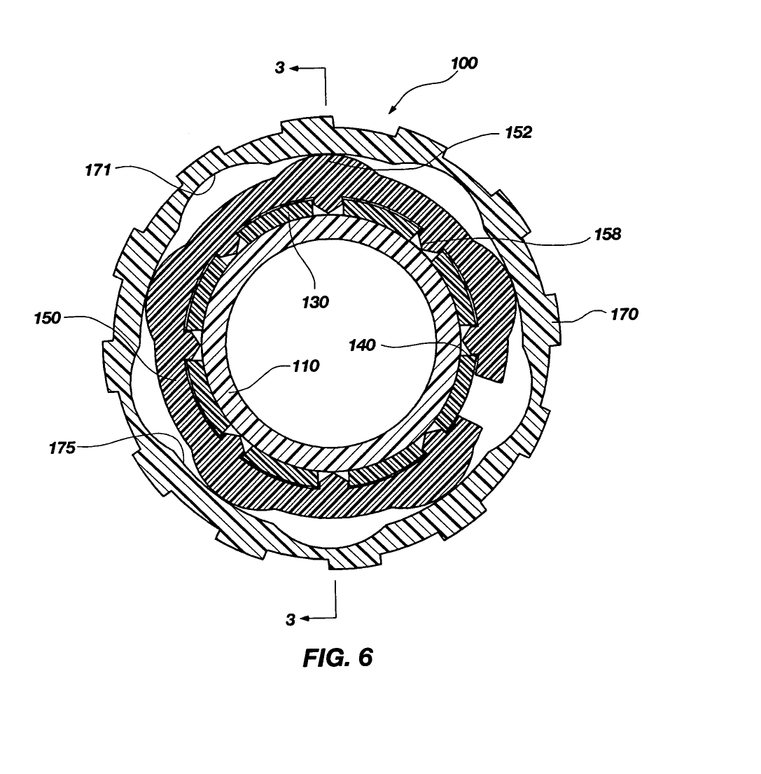

Optionally, internal flutes 171 may be circumferentially spaced about the second segment 177 of the coupling nut first component 170 for receiving circumferentially spaced cam lobes 152 protruding from the outer cylindrical surface of the split ring 150. (FIG. 3) A cross-sectional view of the coupling is shown in FIG. 6. The internal flutes 171 of the coupling nut 160, and the associated cam lobes 152 of the split ring 150 are shown, with the cam lobes 152 engaged with the inside surface 175 of the coupling nut 160. The inwardly facing protrusions 158 of the split ring 150 are received within the apertures 140 of the tube 130, securing the flared end 136 of the tube 130 about the fitting body 110.

Turning again to FIG. 3, the split ring 150 may have tapered side walls. A first tapered annular surface 156, when the coupling nut 160 is tightened thereon, will help force the split ring 150 tightly against the tube 130. An opposing, second tapered annular surface 154 may be engaged as the coupling nut 160 is removed, forcing the split ring 150 radially outward.

The second segment 177 of the coupling nut first component 170 includes a tapered pushing edge 104 configured to engage with the second tapered annular surface 154 of the split ring 150. When the coupling nut 160 is unscrewed, the tapered pushing edge 104 of the first component 170 may engage the second tapered annular surface 154 of the split ring 150, and urge the split ring out of the apertures 140 and into the annular recess 165 of the coupling nut 160. The second tapered annular surface 154 of the split ring 150 extends radially outwardly, while extending longitudinally toward the externally threaded portion 114 of the fitting body 110. The tapered pushing edge 104 of the first component second segment 177 may partially define an annular channel 106 extending into the third segment 179 of the coupling nut first component 170 for receiving the second tapered annular surface 154 and associated portion of the split ring 150. The annular channel 106 is in communication with the second section 176 of the bore, configured for receiving the remainder of the split ring 150.

A first longitudinal end of the first segment 173 of the first component 170 may optionally include a flange 109 protruding from the end surface. As shown in FIG. 3, the flange 109 of the first component 170 may be received within an associated groove 189 circumferentially disposed about the second component 180. The flange 109 and groove 189 may assist in preventing the first component 170 from splaying outward as the threads of the first component 170 and the second component 180 push one another apart. Alternatively, the second component 180 may include a flange, and the first component 170 may include an associated, circumferentially disposed groove.

The bore 172 of the first component 170 includes a plurality of sections, as described hereinabove, and each segment of the bore 172, from a first longitudinal end of the first component to a second longitudinal end of the first component, is progressively larger in diameter than the previous, adjacent bore segment. Therefore, the first component 170 may be molded, using a suitable material including, but are not limited to, polymeric materials such as fluoropolymeric compounds such as tetrafluoroethylene (TFE), polytetrafluoroethylene (PTFE), fluorinated ethylene-propylene (FEP), perfluoroalkoxy fluorocarbon resin (PFA), polychlorotrifluoroethylene (PCTFE), ethylene-chlorotrifluoroethylene copolymer (ECTFE), ethylene-tetrafluoroethylene copolymer (ETFE), polyvinylidene fluoride (PVDF), and polyvinyl fluoride (PVF). Other suitable materials include polyvinyl chloride (PVC), chlorinated polyvinyl chloride (CPVC), polypropylene, polyethylene, high density polyethylene, acrylonitrile butadiene styrene (ABS), a thermal setting plastic, a thermal plastic, or a plastic with property enhancing additives.

The coupling nut second component 180 may include a bore 182 therethrough, as shown in FIG. 5. The bore 182 may include a plurality of sections, each section having a different diameter. A first section 184 may be defined by a first segment of the second component 180, and may be frustoconical in shape, configured to receive the split ring 150 therein. A side wall 185 defining the first section 184 of the bore may be inclined, the first section 184 having a larger diameter at a first end and a smaller diameter at a second end. A second section 186 of the bore 182 may be cylindrical, and may be configured to receive the flared end 136 of the tube 130 therein. A third section 188 may be cylindrical in shape, and be configured to receive a body portion 134 of the tube 130 therein.

The side wall 185 of the second component may be configured to engage with the first tapered annular surface 156 of the split ring 150. (See FIG. 3) The first tapered annular surface 156 may help force the split ring 150 tightly against the tube 130 and prevent binding of the split ring 150 between the coupling nut 160 and the tube 130. The tapered side wall 185 defining the first, frustoconical bore section 184 may abut the first tapered annular surface 156 as the coupling nut 160 is being tightened over the fitting body 110, forcing the split ring 150 radially inwardly. Radially outward movement or extrusion of the split ring 150 may thus be prevented. When assembled as the coupling nut 160, the first, frustoconical bore section 184 of the second component 180 and the second bore section 176 of the first component 170 form an internal annular recess of the coupling nut 160, configured for receiving the split ring 150 therein.

A portion of an outside surface 181 of the second component 180 may be threaded for matingly engaging threads of the first component 170. The threaded portion 181 on one longitudinal end of the second component 180 may have a smaller outside diameter than the other longitudinal end. The longitudinal end having the greater outside diameter protrudes beyond the threaded end, forming a stop face 183 therebetween which may include the groove 189 therein. The maximum outside diameter of the second component 180 may be substantially similar to the maximum outside diameter of the first component 170. Thus, the coupling nut 160 may have a substantially continuous outside diameter.

The second component 180 is depicted with the second section 186 of the bore 182 extending longitudinally within the second component 180 to the same point as the threaded outside surface 181. However, it is also within the scope of the present invention for the second section 186 of the bore 182 to extend within the second component 180 to a different depth than the threaded outside surface 181.

The second component 180 may be formed by molding, and may comprise a suitable material including, but are not limited to, polymeric materials such as those described hereinabove with respect to the first component 170.

The first component 170 and the second component 180 may be threadedly connected to form the coupling nut 160, as shown in FIG. 3. Forming the coupling nut 160 with two components enables a simple molding process. Each component 170, 180 includes a bore having a progressively greater diameter. Thus, each component may be molded and removed from the mold without collapsing a mold half. As described hereinabove, molding a conventional coupling nut having a bore including an internal annular recess requires additional manufacturing time and expense.

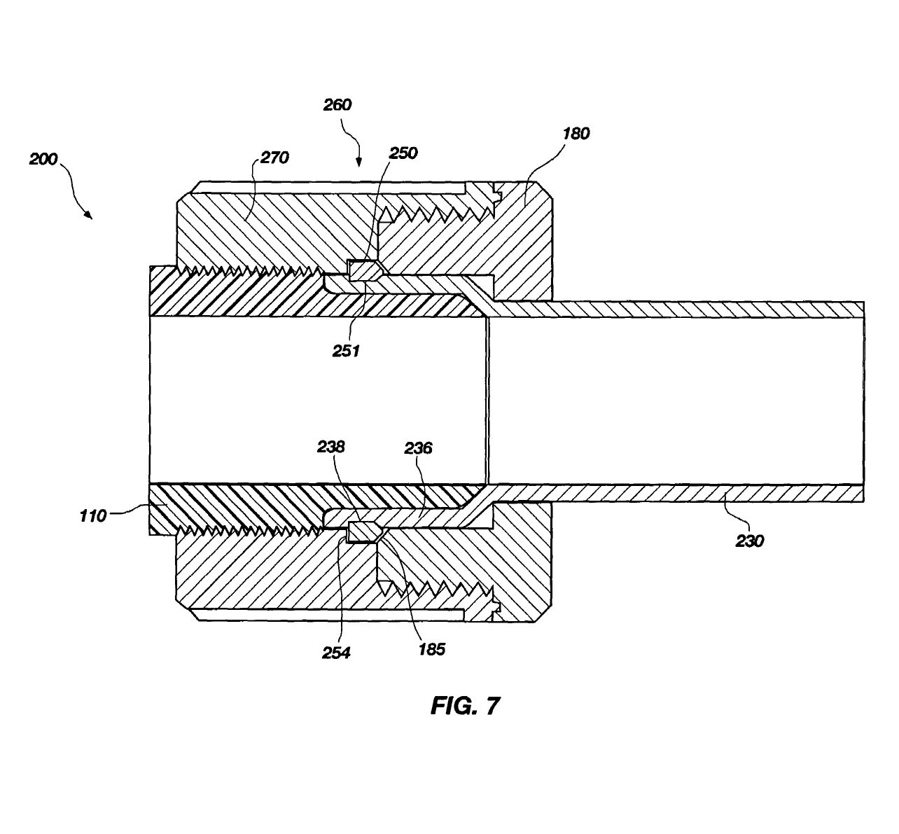

In another embodiment of a coupling 200 of the present invention, as shown in FIG. 7, a fitting body 110 may be telescopically receivable within a flared end 236 of a tube 230. The flared end 236 may include a circumferential groove 238 around an outer periphery thereof. A resiliently deformable split ring 250 may be disposed about the flared end 236 and include a projecting lip with an inner face 251 around the inner periphery of the split ring 250 receivable within the circumferential groove 236 of the tube 230. A coupling nut 260 comprising a first component 270 and a second component 180 may be disposed about a junction of the fitting body 110 and tube 230, holding the split ring 250 about the junction. A side wall portion 185 of the second component 180 may be tapered, as shown.

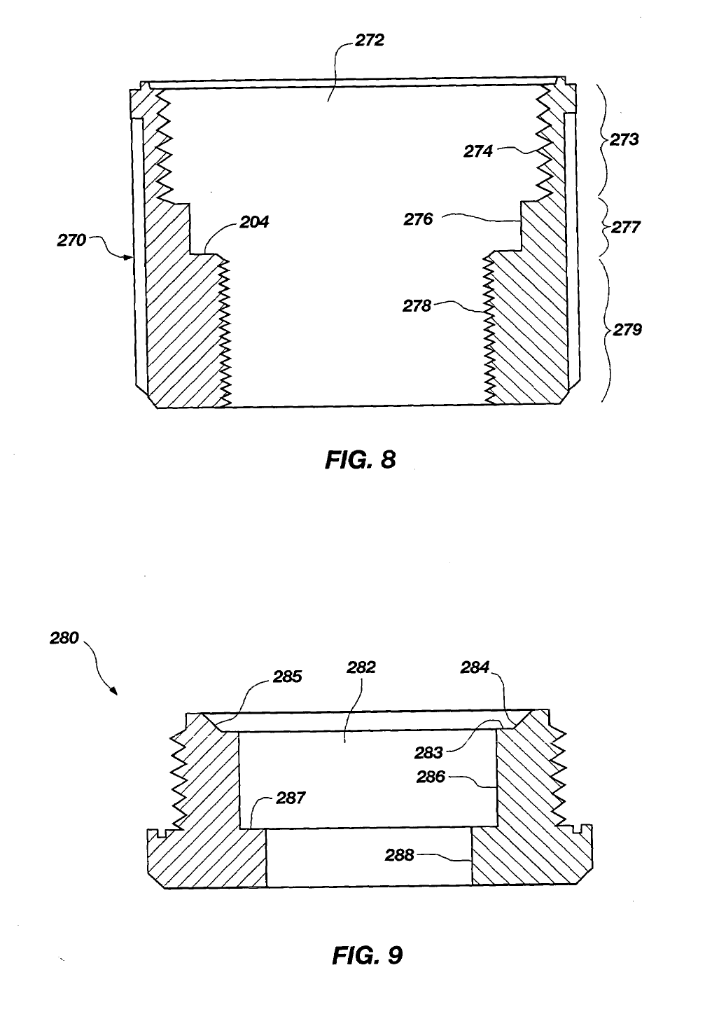

The first component 270 of the coupling nut 260 depicted in FIG. 7 is shown in detail in FIG. 8. The first component 270 includes a bore 272 therethrough, the bore 272 having at least three sections, each with a different cross-sectional area. The first bore section 274 may have the greatest diameter of the three sections. A first segment 273 of the coupling nut first component 270 may define the first bore section 274, and may be internally threaded. The second bore section 276, defined by a second segment 277 of the coupling nut first longitudinal component 270, may be configured to receive the split ring 250 therein, and may have a diameter smaller than the diameter of the first bore section 274. An inside facing surface of the second segment 277 may be substantially smooth, or unfeatured, to receive the split ring 250 therein. The third bore section 278, defined by a third segment 279 of the coupling nut first component 270, may be internally threaded, and may have a diameter smaller than the diameter of the second bore section 276. The externally threaded portion 114 of the fitting body 110 and the internal threads of the third segment 279 of the coupling nut 260 may be configured for mating engagement.

The second segment 277 and the third segment 279 of the coupling nut first component 270 may join with a stop wall 204 substantially orthogonal to the inside facing walls of the second segment 277 and the third segment 279, defining the second bore section 276 and the third bore section 278. Returning to FIG. 7, the split ring 250 may have a radially extending surface 254 substantially orthogonal to the inside facing surface 238, and configured to abut the stop wall 204.

Another embodiment of a second component 280 of a coupling nut of the present invention is depicted in FIG. 9. The second component 280 may be attached with a first component 170, 270 to form a coupling nut. The second component may include a bore 282 extending longitudinally therethrough. The bore 282 may include a plurality of sections, each section having a different cross-sectional size or diameter. A first section 284 may be defined by a first segment of the second component 280, and may be frustoconical in shape, configured to receive a portion of the deformable split ring 150, 250 therein. The sidewall 285 of the first section 284 of the bore may be inclined, with a larger diameter at a first end and a smaller diameter at a second end. A second section 286 of the bore 282 may be cylindrical, with a diameter greater than the smallest diameter of the bore first section 284. A radially extending stop face 283 may join the inside facing surface defining the bore second section 286 and the inclined sidewall 285 of the bore first section 284. A third section 288 may be cylindrical in shape, and be configured to receive the body portion 134 of the tube 130 therein. A radially extending stop face 287 may join the inside facing surface defining the bore second section 286 and inside facing surface defining the bore third section 288.

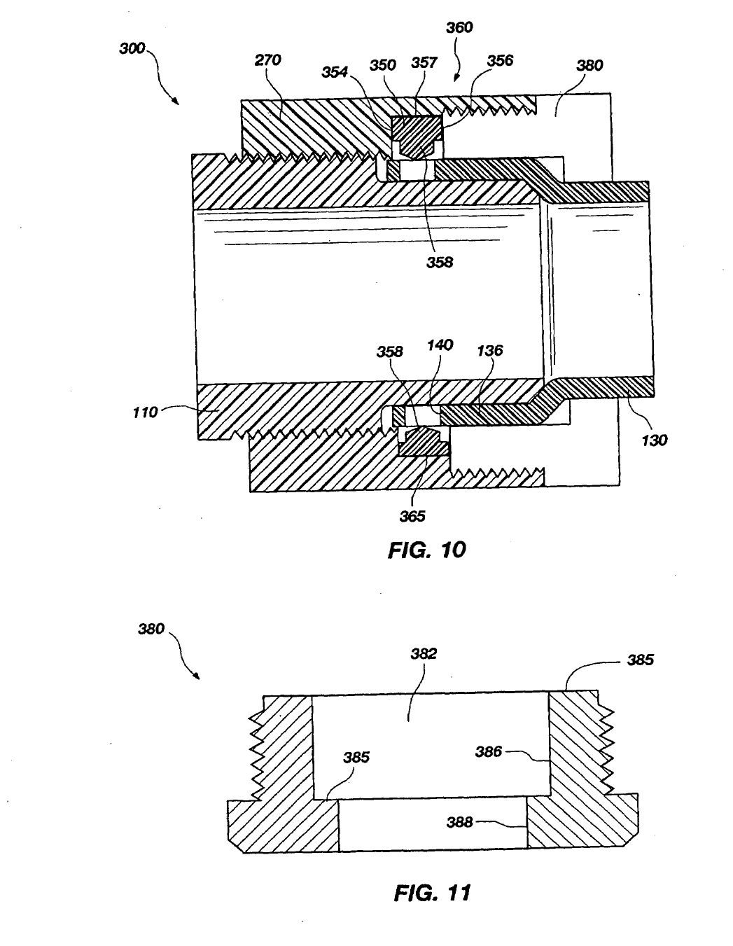

In yet another embodiment of a coupling 300 of the present invention, as shown in FIG. 10, a fitting body 110 may be telescopically receivable within a flared end 136 of a tube 130. The flared end 136 may include a plurality of apertures 140 spaced circumferentially. A resiliently deformable split ring 350 may be disposed about the flared end 136 and include a plurality of inwardly facing protrusions 358 receivable within the apertures 140 of the tube 130. A coupling nut 360 comprising a first component 270 and a second component 380 may be disposed about a junction of the fitting body 110 and tube 130, holding the split ring 350 about the junction. The split ring 350 may incorporate a generally rectangular cross-section, except in the areas of the inwardly facing protrusions 358. In other words, opposing radially extending surfaces 354, 356 are joined with a substantially orthogonal outward facing surface 357. Outward portions of the split ring 350 may be received by an internal annular recess 365 of the coupling nut 360. The internal annular recess 365, defined by inner sidewalls of a second segment 277 of the first component 270 and a pushing surface 385 of the second component 380 may have a substantially constant diameter, with the exception of optionally included internal flutes for receiving cam lobes of a split ring, as described hereinabove.

The second component 380 of the coupling 300 depicted in FIG. 10 is shown in detail in FIG. 11. The second component 380 includes a bore 382 therethrough, the bore 382 having at least two sections, each with a different cross-sectional area. The first bore section 386 may have the greater diameter of the two sections, and may be configured to receive the flared end 136 of the tube 130 therein. A third section 388 may be cylindrical in shape, and be configured to receive the body portion 134 of the tube 130 therein. A distal end of the second component 380 may include a radially extending pushing surface 385 which may form a wall of the internal annular recess 365 of the coupling nut 360 and abut the split ring 350 when assembled with the first component 270 of the coupling 300.

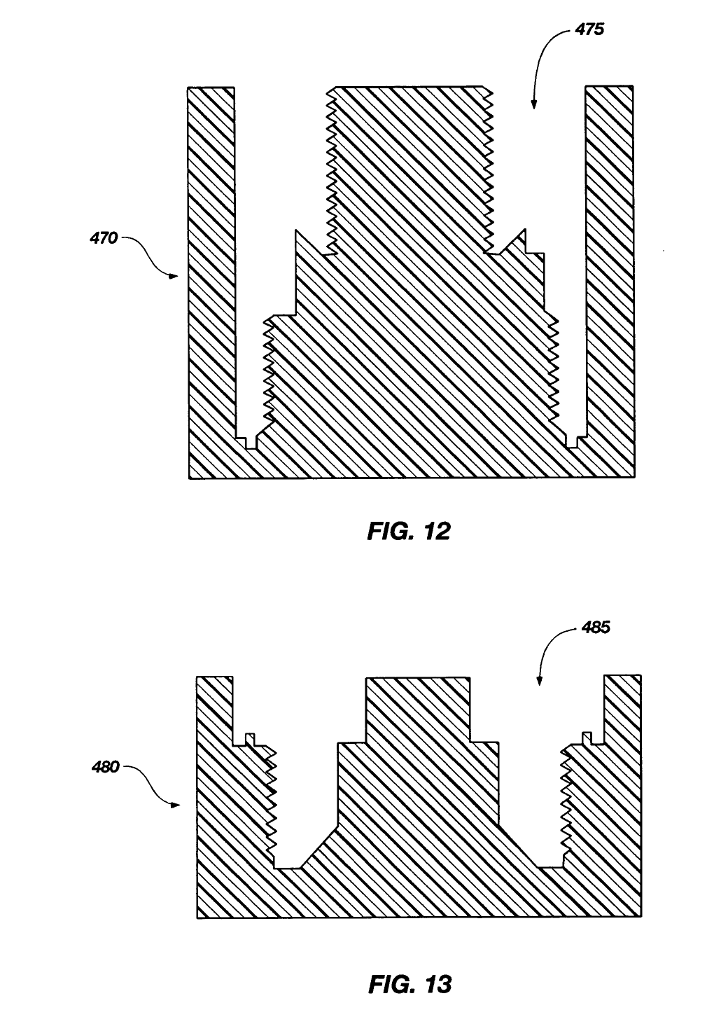

FIG. 12 illustrates a cross-section of first mold 470 for a first component 170, 270 of a coupling nut 160, 260, 360 of the present invention. The first mold 470 includes an annular cavity 475 which may be filled with a suitable flowable material, and hardened. Optionally, a substantially cylindrical first mold half may be provided, and a second mold half may be inserted therein to provide an annular cavity configured for molding a first component 170, 270 of a coupling nut 160, 260, 360 of the present invention. FIG. 13 illustrates a cross-section of second mold 480 for a first component 180, 280, 380 of a coupling nut 160, 260, 360 of the present invention. The second mold 480 may include an annular cavity 485 configured for molding a second component 180, 280, 380.

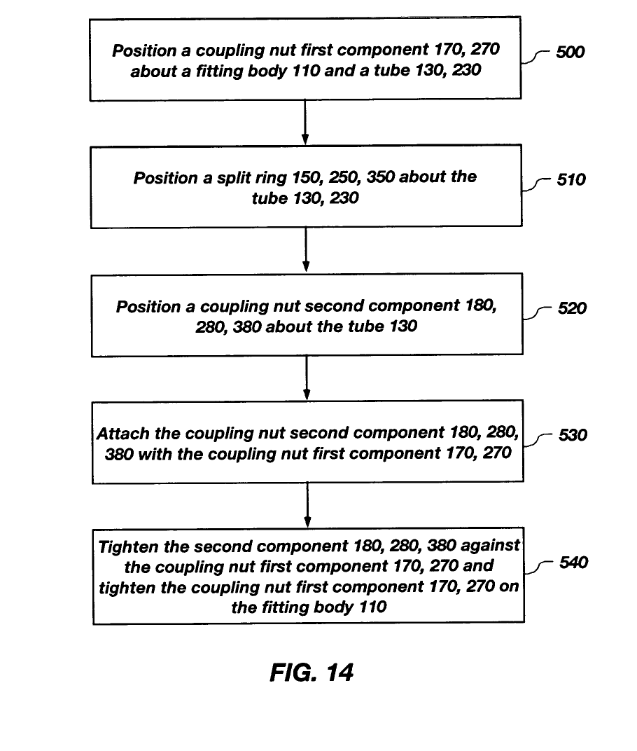

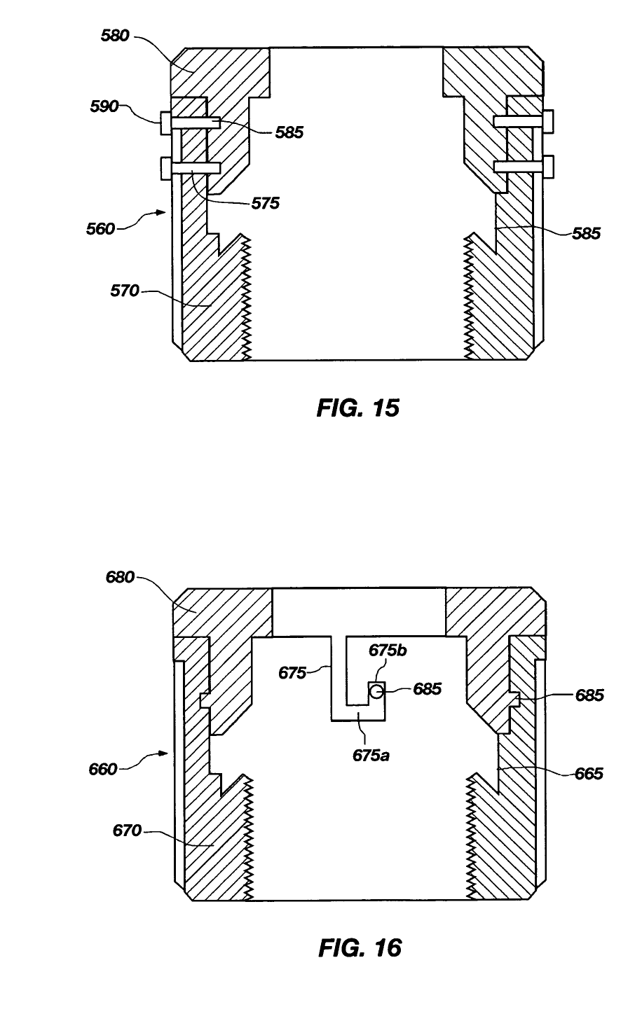

FIG. 14 is a flowchart illustrating the acts of a method of coupling a fitting body 110 with a tube 130. The fitting body 110 may be provided, with a flared end 136 of a tube 130, 230 encircling a portion of the fitting body 100. A coupling nut first component 170, 270 may be positioned about the fitting body 110 and tube 130, 230. See Act 500. The coupling nut first component 170, 270 may include threads on an inner surface thereof, and may be loosely engaged with outward facing threads 114 of the fitting body 110. A split ring 150, 250, 350 may be disposed about the tube 130, 230. See Act 510. The split ring 150, 250, 350 may include a plurality of inwardly facing protrusions 158, 358 or an inner lip 251 which may be received within spaced apertures 140 of the tube 130 or a circumferential groove 238 of the tube 230. The split ring 150, 350 may be adjusted as necessary in order to align the inwardly facing protrusions 158, 358 with the spaced apertures 140 of the tube 130. Aligning the inwardly facing protrusions 158, 358 with the spaced apertures 140 of the tube 130 may eliminate the need for internal flutes in the annular recess of the coupling nut for receiving cam lobes of a split ring. Rather, the annular recess may be sized to secure the split ring in place.

A coupling nut second component 180, 280, 380 may be positioned about the tube 130, 230. See Act 520. The coupling nut second component 180, 280, 380 may be threadedly attached to the coupling nut first component 170, 270. See Act 530. The coupling nut second component 180, 280, 380 tightened with the coupling nut first component 170, 270, and the coupling nut first component 170, 270 may be tightened to the fitting body 110, securing the fitting body 110 and the tube 130, 230 together. See Act 540.

The first component 170, 270 and the second component 180, 280, 380 may be threadedly coupled, as shown in FIGS. 3, 7, and 10, however, other methods of coupling the first component 170, 270 and the second component 180, 280, 380 are within the scope of the present invention. Referring back to FIGS. 4 and 5, the first bore section 174 of the first component may be defined by a substantially smooth, rather than threaded, sidewall. The outside surface 181 of the second component 180 may likewise be substantially smooth, rather than threaded, and the first component 170 and the second component 180 may be force fit together. Another suitable method of coupling the first component 170, 270 and the second component 180, 280, 380 is welding.

FIG. 15 depicts another embodiment of a coupling nut 560 of the present invention. The coupling nut 560 includes a first component 570 and a second component 580 which may be coupled together. The coupling nut 560 includes an annular recess 565. The first component 570 and the second component 580 may have substantially smooth inner and outer side walls, respectively, and may be securely coupled using attachment elements 590. The attachment elements 590 may comprise, for example, screws, rivets, or bolts. The attachment elements 590 may be circumferentially spaced about the first component 570 and may matingly engage with respectively spaced apertures 575 therethrough. The attachment elements 590 may extend through the apertures 575 of the first component 570 to spaced cavities 585 of the second component 580, or the attachment elements 590 may be screwed directly into the material of the second component 580. Two rows of circumferentially spaced attachment elements 590 are depicted in FIG. 15, however, it will be understood that any number of attachment elements 590 may be used to attach the first component 570 and the second component 580.

Turning to FIG. 16, another embodiment of a coupling nut 660 of the present invention is shown. The coupling nut 660 includes a first component 670 and a second component 680 which may be coupled together. The coupling nut 660 includes an annular recess 665. The first component 670 and the second component 680 may have substantially smooth inner and outer side walls, respectively, and may be secured together with protruding bosses 685 of the second component 680 and associated grooves 675 of the first component 670. The grooves may be “L” or “J” shaped. The second component 680 may be inserted in the first component 670 with the bosses 685 aligned with the grooves 675. The bosses 685 may slide longitudinally on the first component 670, through the grooves 675, as the second component 680 is moved into the first component 670. The second component 680 may be twisted within the first component 670, and the bosses 658 may travel through a circumferentially extending portion 675a of the grooves 675. A final portion 675b of the groove 675 may be longitudinally extending, and the second component 680 may be drawn longitudinally outward from the first component 670 to secure the first component 670 and the second component 680 together. FIG. 16 depicts a “J” shaped groove 685 having a final, longitudinally extending portion 675b, however, it will be understood that a “L” shaped groove, without a final, longitudinally extending portion is within the scope of the present invention.

Although specific embodiments have been shown by way of example in the drawings and have been described in detail herein, the invention may be susceptible to various modifications, combinations, and alternative forms. For example, a coupling nut having an internal annular recess of any shape, and a coupling nut component having a bore of any cross-sectional shape are within the scope of the present invention. One embodiment of using the coupling nut of the present invention is described in FIG. 14, however, it will be understood that there are many methods of using a coupling nut of the present invention. Therefore, it should be understood that the invention is not intended to be limited to the particular forms disclosed. Rather, the invention includes all modifications, equivalents, combinations, and alternatives falling within the spirit and scope of the invention as defined by the following appended claims.

1. A coupling assembly, comprising:
a fitting body;
a tube configured for telescopically receiving the fitting body;
a ring disposed about the tube; and
a coupling nut comprising at least two components disposed about the tube and the ring.

2. The coupling of claim 1, wherein the ring is a resiliently deformable split ring.

3. The coupling of claim 1, wherein the at least two components of the coupling nut include a first annular component having exterior threads and a second annular component having at least two sets of interior threads.

4. The coupling of claim 3, wherein the second annular component includes a first set of left-hand threads and a second set of right-hand threads.

5. The coupling of claim 3, wherein the second annular component includes a first set of threads configured to matingly engage the exterior threads of the first annular component and a second set of threads configured to matingly engage exterior threads of the fitting body.

6. The coupling of claim 1, wherein the tube includes a plurality of spaced apertures therethrough and wherein the ring includes a plurality of inwardly facing bosses that fit into and cooperate with the plurality of spaced apertures.

7. The coupling of claim 1, wherein the ring includes an inwardly projecting lip extending into an annular groove within the tube.

8. The coupling of claim 1, wherein the coupling nut comprises an annular body, and the at least two components comprise a first longitudinal end of the annular body and a second longitudinal end of the annular body.

9. The coupling of claim 8, wherein the annular body of the coupling nut includes an internal annular recess.

10. The coupling of claim 9, wherein the ring includes a body portion having a rectangular cross-section and wherein the internal annular recess comprises a counterbore of constant diameter for receiving the ring body portion.

11. The coupling of claim 9, wherein the internal annular recess includes internal flutes.

12. The coupling of claim 9, wherein the internal annular recess includes at least one tapered surface.

13. The coupling of claim 12, wherein the internal annular recess includes a second tapered surface, substantially parallel to the at least one tapered surface.

14. The coupling of claim 12, wherein the ring includes a tapered edge abutting the at least one tapered surface of the internal annular recess.

15. The coupling of claim 1, wherein the at least two components of the coupling nut comprise:
a first component having a bore therethrough, the bore including at least three sections, each of the three sections having a diameter greater than a diameter of a preceding section; and
a second component having a bore therethrough, the bore including at least two sections, one section having a diameter greater than a diameter of the other section.

16. The coupling of claim 1, wherein the coupling nut comprises a polymeric material.

17. The coupling of claim 1, wherein the at least two components of the coupling nut include a first annular component and a second annular component at least partially telescopically received therein.

18. The coupling of claim 17, wherein the first annular component includes a plurality of spaced apertures, and the coupling further comprising a like plurality of attachment elements, each disposed through an aperture of the plurality of spaced apertures, and securing the first annular component with the second annular component.

19. The coupling of claim 17, wherein the second annular component includes a plurality of protruding bosses and the first annular component includes a like plurality of grooves.

20. A coupling nut, comprising:
a first component having a bore therethrough, the bore including:
a first section having a first diameter;
a second section adjacent to the first section and having a second diameter lesser than the first diameter; and
a third section adjacent to the second section and having a third diameter lesser than the second diameter; and
a second component having a first end receivable by the first section of the first component bore and having a bore therethrough, the bore including at least two sections, one section having a diameter greater than a diameter of the other section.

21. The coupling nut of claim 20, wherein the first component is threadedly coupled with the second component.

22. The coupling nut of claim 20, wherein a portion of the first component defining the first section of the bore includes internal threads, and the first end of the second component includes external threads configured for engagement with the internal threads of the first component.

23. The coupling nut of claim 22, wherein a portion of the first component defining the third section of the bore includes right-hand internal threads and the internal threads of the portion of the first component defining the first section of the bore are left-hand threads.

24. The coupling nut of claim 22, wherein a portion of the first component defining the third section of the bore includes left-hand internal threads and the internal threads of the portion of the first component defining the first section of the bore are right-hand threads.

25. The coupling nut of claim 23, wherein a portion of the first component defining the second section of the bore includes circumferentially disposed internal flutes.

26. The coupling nut of claim 20, wherein the first component further comprises a flange configured for engagement with an annular groove of the second component.

27. The coupling nut of claim 20, wherein the bore of the second component further comprises an outwardly flaring end section.

28. The coupling nut of claim 20, wherein the first component further comprises an annular channel with a tapered sidewall in open communication with the second section of the bore.

29. The coupling of claim 20, wherein the first component and the second component each comprise a polymeric material.

30. A method of forming a coupling nut, comprising:
molding a first component having a bore therethrough, the bore having at least three successive sections, each successive section having a diameter greater than the adjacent section;
molding a second component having a bore therethrough, the bore having at least two successive sections, each successive section having a diameter greater than the adjacent section; and
coupling the first component with the second component to form a coupling nut having an internal annular recess and a bore extending therethrough.

31. The method of claim 30, wherein coupling the first component with the second component comprises threadedly coupling the first component with the second component.

32. The method of claim 30, wherein molding the first component comprises molding right-hand threads in a first end segment of the first component, defining a first end section of the bore and molding left-hand threads in a second end segment of the first component, defining a second end section of the bore.

33. The method of claim 30, wherein molding the first component comprises molding a central segment of the first component, defining a central section of the bore, with a plurality of flutes.

34. A method of coupling a fitting body with a tube, comprising:
providing the fitting body;
positioning the tube with an end portion thereof receiving a portion of the fitting body;
encircling a portion of the fitting body and a portion of the tube with a first coupling nut component;
positioning a ring about the tube;
encircling the ring and a portion of the tube with a second coupling nut component; and
securing the first coupling nut component to the second coupling nut component.

35. The method of claim 34, further comprising engaging a plurality of protruding bosses of the ring with a plurality of spaced apertures of the tube.

36. The method of claim 34, further comprising mating a lip of the ring with an annular groove of the tube.
